(19) United States
(12) Patent Application Publication
(10) Pub. No.: US 2010/0303167 A1
(43) Pub. Date: Dec. 2, 2010

(54) HIERARCHICAL MODULATION SYSTEM AND TRANSMITTER AND METHOD THEREOF

(75) Inventors: Rong-Terng Juang, Changhua County (TW); Pang-An Ting, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/512,001

(22) Filed: Jul. 29, 2009

(30) Foreign Application Priority Data
Jun. 1, 2009 (TW) 98118034

(51) Int. Cl. H04L 1/02; H04L 27/36

(52) U.S. Cl. 375/267; 375/298

(57) ABSTRACT

An exemplary embodiment of the present invention proposes a transmitter including a hierarchical modulator. The hierarchical modulator receives, jointed encodes, and maps a high-priority and low-priority bit-stream signals, so as to generate multiple mapping signal, wherein each mapping signal is the summation of a low-priority and high-priority mapping signals. The low-priority mapping signal is the complex number signal on the frequency domain to which part bits of the low-priority bit-stream signal are mapped, and the high-priority mapping signal is the complex number signal on the frequency domain to which part bits of the high-priority bit-stream signal are mapped. The p^{th} low-priority mapping signal is related to (p+1)^{th} low-priority mapping signal, and p is an even number or an odd number.

### CROSS-REFERENCE TO RELATED APPLICATION

This application claims the priority benefit of Taiwan application serial no. 98118034, filed on Jun. 1, 2009. The entirety of the above-mentioned patent application is hereby incorporated by reference herein and made a part of specification.

### TECHNICAL FIELD

The present invention generally relates to a hierarchical modulation system, a transmitter thereof, and a method thereof, and more particularly to a hierarchical modulation system using the orthogonal frequency division multiplexing (OFDM) modulation.

### BACKGROUND

OFDM is a frequency domain data multiplexing technology. The modulated symbol is conveyed on a sub-carrier on the frequency domain, and the sub-carriers are orthogonal to each other on the frequency domain. Assuming the perfect frequency synchronization is performed to the transmitter and receiver (i.e. no frequency offset), and therefore the orthogonality of the sub-carriers still maintain after being sampled. However, when the channel fades fast, the phenomenon of frequency offset OFDM, the phase noise, and the Doppler are occurred in the OFDM system, and thereby the orthogonality of the sub-carriers is destroyed. Thus the inter-carrier interference (ICI) is occurred in the OFDM system, and the larger bit error rate (BER) is obtained.

The communication system generally adopts the high level modulation, such as 16 Quadrature Amplitude Modulation (16-QAM). Additionally, a hierarchical modulation is proposed and used widely. The hierarchical modulation technology maps part bits of the high-priority bit stream signal to a high-priority mapping signal, and maps part bits of the low-priority bit stream signal to a low-priority mapping signal. Next, the hierarchical modulation technology adds the high-priority mapping signal and the low-priority mapping signal, so as to obtain a mapping signal to be transmitted, wherein the high-priority mapping signal, the low-priority mapping signal, and the mapping signal are complex number signals.

### SUMMARY

An exemplary embodiment provides a hierarchical modulation system comprising a transmitter and receiver. The transmitter comprises a hierarchical modulator and an OFDM modulator. The hierarchical modulator receives a high-priority bit stream signal and a low-priority bit stream signal, and performs a joint encoding and a hierarchical modulation on the high-priority bit stream signal and a low-priority bit stream signal, so as to generate a plurality of mapping signals, wherein each mapping signal is the summation of a high-priority mapping signal and a low-priority mapping signal. The high-priority mapping signal is a complex number signal on the frequency domain to which part bits of the encoded high-priority bit stream signal are mapped, and the low-priority mapping signal is a complex number signal on the frequency domain to which part bits of the encoded low-priority bit stream signal are mapped. The p^{th} low-priority mapping signal of the low-priority mapping signals is related to (p+1)^{th} low-priority mapping signal of the low-priority mapping signals, and p is an even number or an odd number. The OFDM modulator receives the mapping signals, and performs an OFDM modulation on the mapping signals, so as to generate a time domain OFDM signal. The receiver receives the time domain OFDM signal, and performs an OFDM demodulation, a hierarchical demodulation, and a joint decoding on the time domain OFDM signal, so as to obtain the high-priority bit stream signal and the low-priority bit stream signal.

An exemplary embodiment provides a hierarchical modulation transmitter comprising a hierarchical modulator. The hierarchical modulator receives a high-priority bit stream signal and a low-priority bit stream signal, and performs a joint encoding and a hierarchical modulation on the high-priority bit stream signal and a low-priority bit stream signal, so as to generate a plurality of mapping signals, wherein each mapping signal is the summation of a high-priority mapping signal and a low-priority mapping signal. The high-priority mapping signal is a complex number signal on the frequency domain to which part bits of the encoded high-priority bit stream signal are mapped, and the low-priority mapping signal is a complex number signal on the frequency domain to which part bits of the encoded low-priority bit stream signal are mapped. The p^{th} low-priority mapping signal of the low-priority mapping signals is related to (p+1)^{th} low-priority mapping signal of the low-priority mapping signals, and p is an even number or an odd number.

An exemplary embodiment provides a hierarchical modulation method. First, a joint encoder is used to perform a joint encoding on a first high-priority bit stream signal and a low-priority bit stream signal. Next, a mapper is used to perform a hierarchical modulation on the encoded high-priority bit stream signal and the encoded low-priority bit stream signal, so as to generate a plurality of mapping signals, wherein each mapping signal is the summation of a high-priority mapping signal and a low-priority mapping signal. The high-priority mapping signal is a complex number signal on the frequency domain to which part bits of the encoded high-priority bit stream signal are mapped, the low-priority mapping signal is a complex number signal on the frequency domain to which part bits of the encoded low-priority bit stream signal are mapped. The p^{th} low-priority mapping signal of the low-priority mapping signals is related to (p+1)^{th} low-priority mapping signal of the low-priority mapping signals, and p is an even number or an odd number. Then, an OFDM modulator is used to perform an OFDM modulation on the mapping signals, so as to generate a time domain OFDM signal.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a hierarchical modulation system according to an exemplary embodiment.

FIG. 2 is a constellation map for the hierarchical modulation in the hierarchical modulation system of FIG. 1.

FIG. 3 is a table showing the modulation order of the hierarchical modulation manner according an exemplary embodiment.

FIG. 4 is a flow chart showing steps of the hierarchical modulation method according to an exemplary embodiment.

### DESCRIPTION OF THE EMBODIMENTS

An exemplary embodiment provides a hierarchical modulation system, a transmitter thereof, and a method thereof, which can decrease ICI. Reference will now be made in detail to the present preferred embodiment of the invention, examples of which are illustrated in the accompanying drawings. Wherever possible, the same reference numbers are used in the drawings and the description to refer to the same or like parts. It is noted that, the following exemplary embodiment is not used to limit the present invention.

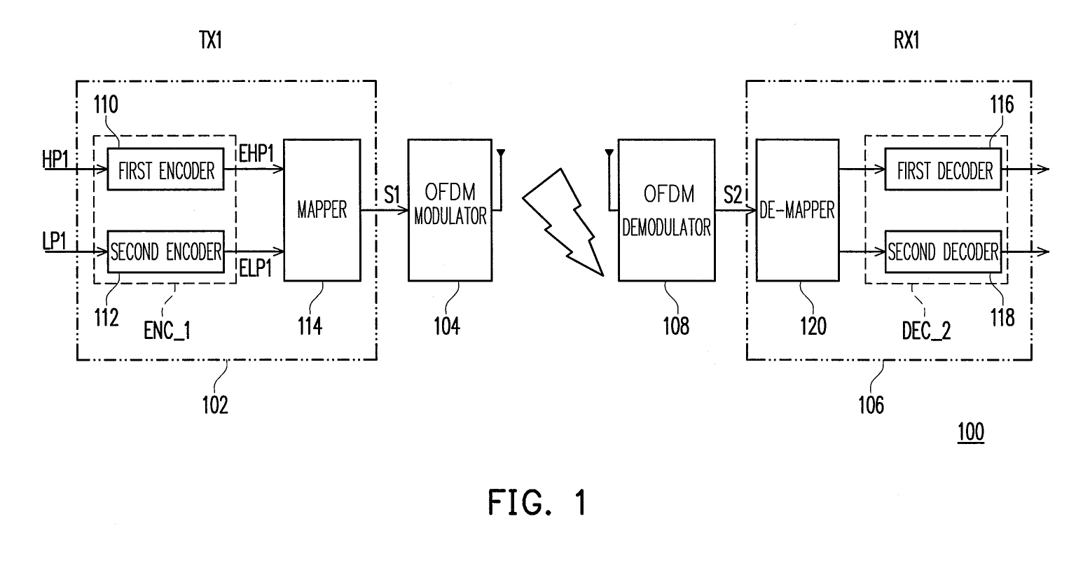

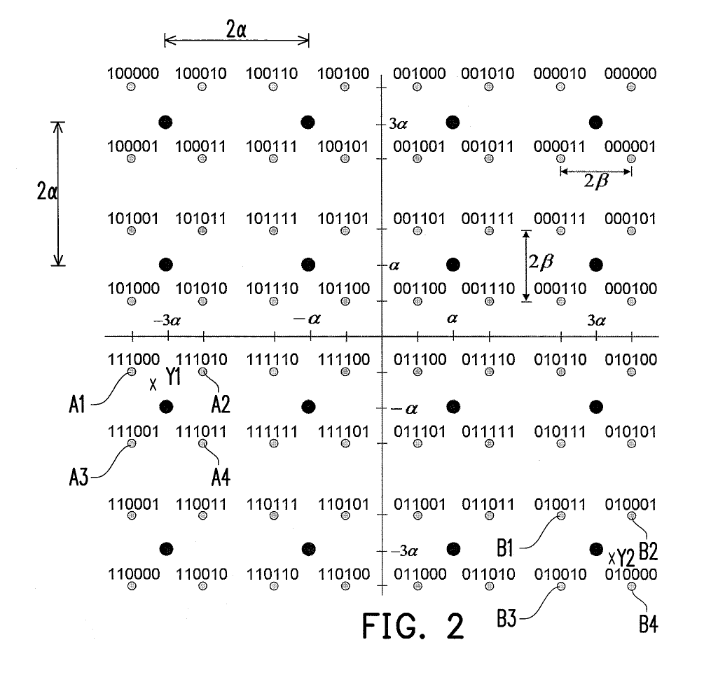

FIG. 1 is a block diagram of a hierarchical modulation system according to an exemplary embodiment. FIG. 2 is a constellation map for the hierarchical modulation in the hierarchical modulation system of FIG. 1. In FIG. 1, the hierarchical modulation system 100 can be applicable to the wireless transmission or the wired transmission, and specifically to the wireless transmission with the high and low priorities.

Referring to FIG. 1, the hierarchical modulation system 100 comprises a transmitter TX1 and a receiver RX1. The transmitter TX1 comprises a hierarchical modulator 102 and an OFDM modulator 104, and the receiver RX1 comprises a hierarchical demodulator 106 and an OFDM demodulator 108, wherein the hierarchical modulator 102 comprises a joint encoder ENC_1 and a mapper 114. The joint encoder ENC_1 can be implemented by the two encoders 110 and 112 which communicate to each other. However the present disclosure is not limited thereto. In addition, the hierarchical demodulator 106 comprises a joint decoder DEC_2 and a de-mapper 120, wherein the joint decoder DEC_2 can be implemented by the two decoder 116 and 118 which communicate to each other. However the present disclosure is not limited thereto.

The hierarchical modulator 102 receives a high-priority bit stream signal HP1 and a low-priority bit stream signal LP1, and performs a joint encoding and a hierarchical modulation on the high-priority bit stream signal HP1 and the low-priority bit stream signal LP1, so as to generate multiple mapping signals S1, wherein the high-priority bit stream signal HP1 and the low-priority bit stream signal LP1 are both the bit stream signals, and the mapping signals S1 are complex number signals.

Each of the mapping signals S1 is a summation of the high-priority mapping signal and the low-priority mapping signal. The high-priority mapping signal is a complex number signal on the frequency domain to which part bits of the encoded high-priority bit stream signal EHP1 are mapped, and the low-priority mapping signal is a complex number signal on the frequency domain to which part bits of the encoded low-priority bit stream signal ELP1 are mapped. The p^{th} low-priority mapping signal of the low-priority mapping signals is related to (p+1)^{th} low-priority mapping signal of the low-priority mapping signals, and p is an even number or an odd number

The OFDM modulator 104 performs an inverse fast Fourier transformation (IFFT) on the mapping signals S1 corresponding multiple sub-carriers, and then adds a cyclic prefix (CP) on the transformed mapping signals, so as to generate a time domain OFDM signal. In other words, the OFDM modulator 104 performs the OFDM modulation on the mapping signals S1 corresponding to the sub-carriers, so as to generate the time domain OFDM signal.

The OFDM demodulator 108 receives the time domain OFDM signal transmitted from the OFDM modulator 104, removes the CP of the time domain OFDM signal, and performs a fast Fourier transformation (FFT) on the time domain OFDM signal with the CP, so as to generate a frequency domain OFDM signal, wherein the frequency domain OFDM signal comprises the signals S2 of the corresponding sub-carriers to be de-mapped. In other words, the OFDM demodulator 108 performs an OFDM demodulation on the time domain OFDM signal, so as to obtain the signals S2 of the corresponding sub-carriers to be de-mapped.

The hierarchical demodulator 106 performs a hierarchical demodulation and a joint decoding on the signals S2 of the corresponding sub-carriers to be de-mapped, so as to obtain the high-priority bit stream signal HP1 and the low-priority bit stream signal LP1. Please see both FIG. 1 and FIG. 2, in the conventional architecture of the hierarchical modulation, a set of each four bits of the high-priority bit stream signal HP1 and each two bits of the low-priority bit stream signal is mapped to one signal point of multiple white signal points of the constellation map shown in FIG. 2. In the exemplary embodiment, the low-priority bit stream signal LP1 is encoded by the repetition encoding manner, so as to decrease the ICI. Thus in the exemplary embodiment, the high-priority bit stream signal HP1 and the low-priority bit stream signal LP1 are encoded via the joint encoder ENC_1. Next, the mapper 114 maps a set of the four bits of the encoded high-priority bit stream signal EHP1 and two bits of the encoded low-priority bit stream signal ELP1 to one signal point of the white signal points of the constellation map shown in FIG. 2, so as to generate one of the mapping signals S1.

To put plainly, the encoder 110 receives the thigh-priority bit stream signal HP1, and encodes the high-priority bit stream signal, so as to generate the encoded high-priority bit stream signal EHP1. The encoder 112 receives the low-priority bit stream signal LP1, and encodes the high-priority bit stream signal HP1 according to a default encoding manner (such as a repetition encoding manner) and the high-priority bit stream signal HP1, so as to generate the low-priority bit stream signal ELP1. The mapper 114 receives the encoded high-priority bit stream signal EHP1 and the encoded low-priority bit stream signal ELP1 from the encoders 110 and 112, and perform a hierarchical modulation on the encoded high-priority bit stream signal EHP1 and the encoded low-priority bit stream signal ELP1. That is, the mapper 114 maps the encoded high-priority bit stream signal EHP1 and the encoded low-priority bit stream signal ELP1 to a plurality of high-priority mapping signals and a plurality of low-priority mapping signals. For example, a constellation map for the high-priority mapping signal is a 16-QAM map, and a constellation map for the low-priority mapping signal is a QPSK constellation map. However, the modulation manners for the high-priority bit stream signal EHP1 and low-priority bit stream signal ELP1 are not used to limit present disclosure.

After mapping the high-priority bit stream signal EHP1 and the low-priority bit stream signal ELP1 to generate the high-priority mapping signals and the low-priority mapping signals, the mapper 114 adds the high-priority mapping signal and the corresponding low-priority mapping signal, so as to obtain one of the mapping signals S1, wherein each of the mapping signals S1 is one signal point of multiple white signal points of the constellation map shown in FIG. 2.

The receiver RX1 receives the OFDM time domain signal, and performs an OFDM demodulation, a hierarchical demodulation, and a joint decoding on the OFDM time domain signal, so as to obtain the high-priority bit stream signal HP1 and the low-priority bit stream signal LP1. The OFDM demodulator 108 receives the OFDM time domain signal, and performs the OFDM demodulation on the OFDM time domain signal, so as to generate the signals S2 to be de-mapped. The hierarchical demodulator 106 receives the signal S2 to be de-mapped, and performs the hierarchical demodulation and the joint decoding on the signals S2 to be de-mapped, so as to obtain the high-priority bit stream signal HP1 and the low-priority bit stream signal LP1.

To put it concretely, the de-mapper 120 of the hierarchical demodulator 106 receives the signals S2 to be de-mapped, and de-maps the signals S2 to be de-mapped, so as to obtain the encoded high-priority bit stream signal EHP1 and the encoded low-priority bit stream signal ELP1. The joint decoder DEC_2 of the hierarchical demodulator 106 receives the encoded high-priority bit stream signal EHP1 and the encoded low-priority bit stream signal ELP1, and jointly decodes the encoded high-priority bit stream signal EHP1 and the encoded low-priority bit stream signal ELP1, so as to obtain the high-priority bit stream signal HP1 and the low-priority bit stream signal LP1. The first decoder 116 of the joint decoder DEC_2 receives the encoded high-priority bit stream signal EHP1, and decodes the encoded high-priority bit stream signal EHP1 to obtain the high-priority bit stream signal HP1, and the second decoder 118 of the joint decoder DEC_2 receives the encoded low-priority bit stream signal ELP1, and decodes the encoded low-priority bit stream signal ELP1 according to a default decoding manner (such as a repetition decoding manner) and the encoded high-priority bit stream signal EHP1, so as to obtain the low-priority bit stream signal LP1.

Referring to FIG. 2, the mapping concept is next described via the mathematical expression. The mapping signal Xₘ of the m^{th} sub-carrier is expressed as follows:

Xₘ=Qₘ+qₘ (1),

wherein Qₘ=aₘ+jbₘ is the complex number signal on the frequency domain to which part bits of the encoded high-priority bit stream signal EHP1 are mapped, and is also one of the high-priority mapping signals, qₘ=cₘ+jdₘ is the complex number signal on the frequency domain to which part bits of the encoded low-priority bit stream signal ELP1 are mapped, and is also one of the low-priority mapping signals. In the exemplary embodiment, the amplitude values of aₘ and bₘ may possible be one of ±3α and ±α, and the amplitude value of cₘ and dₘ may possible be one of ±β, wherein m is a positive integer. The amplitude values of aₘ and bₘ are determined according to the encoded high-priority bit stream signal EHP1, and the amplitude values of cₘ and dₘ are determined according to the encoded low-priority bit stream signal ELP1.

The default encoding manner for the low-priority bit stream signal ELP1 is assumed to be that the p^{th} low-priority mapping signal qₚ is the negative of the (p+1)^{th} low-priority mapping signal qₚ₊₁, that is qₚ=−qₚ₊₁, and p is an even number or an odd number. When the encoder 112 encodes the low-priority bit stream signal LP1, the two bits of the corresponding p^{th} sub-carrier are encoded to four bits, wherein the first two bits of the encoded four bits are the same as the original two bits and is corresponding to the p^{th} sub-carrier, and the last two bits of the four bits are encoded according to the high-priority mapping signal Qₚ₊₁ and the low-priority mapping signal qₚ. The high-priority mapping signal Qₚ₊₁ is the mapping result of the four bits of the (p+1)^{th} sub-carrier of the high-priority bit stream signal EHP1, and the low-priority mapping signal qₚ is the mapping result of the two bits of the p^{th} sub-carrier of the low-priority bit stream signal ELP1. In other words, the second encoder encodes the low-priority bit stream signal LP1 according to the default encoding manner and the high-priority bit stream signal HP1.

For example, if the bit sequence of the high-priority bit stream signal HP1 is {1000 0110 1111 0001}, and the bit sequence of the low-priority bit stream signal LP1 is {00 10}, then the encoded high-priority bit stream signal EHP1 and the encoded low-priority bit stream signal ELP1 output from the encoders 110 and 112 are respectively {1000 0110 1111 0001} and {00 10 10 00}.

Referring to the constellation map shown in FIG. 2, the bit sequence of the encoded high-priority bit stream signal EHP1 corresponding to the first sub-carrier is “1000”, and the bit sequence “1000” is mapped to the complex number signal, −3α+j3α, on the frequency domain. The bit sequence of the encoded low-priority bit stream signal ELP1 corresponding to the first sub-carrier is “00”, and the bit sequence “00” is mapped to the complex number signal, −β+jβ, on the frequency domain. The bit sequence of the encoded high-priority bit stream signal EHP1 corresponding to the second sub-carrier is “0110”, and the bit sequence “0110” is mapped to the complex number signal, α+j(−3α), on the frequency domain. As stated above, to decrease the ICE, the exemplary embodiment encodes the bit sequence of the encodes low-priority bit stream signal ELP1 corresponding to the second sub-carrier to be “10”, and the bit sequence “10” is mapped to the complex number signal, β+j(−β), on the frequency domain. Thus, the first low-priority mapping signal corresponding to the first sub-carrier is the negative of the second low-priority mapping signal corresponding to the second sub-carrier.

The bit sequence of the encoded high-priority bit stream signal E HP1 corresponding to the third sub-carrier is “1111”, and the bit sequence “1111” is mapped to the complex number signal, −α+j(−α), on the frequency domain. The bit sequence of the encoded low-priority bit stream signal ELP1 corresponding to the third sub-carrier is “10”, and the bit sequence “10” is mapped to the complex number signal, −β+jβ, on the frequency domain. The bit sequence of the encoded high-priority bit stream signal EHP1 corresponding to the fourth sub-carrier is “0001”, and the bit sequence “0001” is mapped to the complex number signal, 3α+j(3α), on the frequency domain. As stated above, to decrease the ICE, the exemplary embodiment of the present invention encodes the bit sequence of the encodes low-priority bit stream signal ELP1 corresponding to the fourth sub-carrier to be “00”, and the bit sequence “00” is mapped to the complex number signal, −β+j(β), on the frequency domain. Thus, the third low-priority mapping signal corresponding to the third sub-carrier is the negative of the fourth low-priority mapping signal corresponding to the fourth sub-carrier.

In FIG. 2, the distance between the two closest black signal points is the minimum Euclidean distance of the black signal points, and is 2α. The distance between the two closest white signal points is the minimum Euclidean distance of the white signal points, and is 2,β. The power-splitting factor is defined as (β/α)², presenting the allocated power ratio of the high-priority mapping signal and the low-priority mapping signal. Since the priority and importance of the high-priority mapping signal are larger than those of the low-priority mapping signal, to decrease the transmission error rate during the period for transmitting the high-priority mapping signal, the signal modulation manner with the less power-splitting factor is adopted, and the more energy is allocated to the high-priority mapping signal. Thus the signal corresponding to the high priority can resist the effect the noise and interference, so as to prevent the transmission error during the period for transmitting the high-priority mapping signal. However, in the case, the low-priority mapping signal is easy to be affected by the noise and the interference. By performing the repetition code on the low-priority bit stream signal LP1, the p^{th} low-priority mapping signal of the low-priority mapping signals is related to (p+1) low-priority mapping signal of the low-priority mapping signals, such as qₚ₊₁=−qₚ. The BER of the low-priority mapping signal is therefore decreased, and the ICI is also decreased. Accordingly, the BER of the high-priority mapping signal is decreased and the BER of the low-priority mapping signal is also decreased.

The signal Yₚ to be de-mapped of the OFDM demodulator 108 in the receiver RX1 corresponding to the p^{th} signal can be expressed as:

Yₚ=Hₚ(Qₚ+qₚ)+ΣCₖ₋ₚH′ₖ(Qₖ+qₖ)+Zₚ=HₚQₚ+Iₚ^{(Q)}+Hₚqₚ+Iₚ^{(q)}+Zₚ (2),

wherein Iₚ^{(Q)}=Σ_{k=0,k≠p}^{N-1}Cₖ₋ₚH′ₖQₖ and Iₚ^{(q)}=Σ_{k=0,k≠p}^{N-1}Cₖ₋ₚH′ₖqₖ are the ICI components introduced by the high-priority mapping signal and low-priority mapping signal. These ICI components decrease the signal to interference plus the noise power ratios (SINRs) of the high-priority mapping signal and low-priority mapping signal. Hₚ is the frequency response of the p^{th} sub-carrier, and Zₚ is the sample value of the additive white Gaussian noise (AWGN), wherein p is an integer larger than 0, and is an even number or an odd number. To prevent the low-priority mapping signal from being affected by the noise and the interference, and to prevent the transmission error of the low-priority mapping signal from being occurred, the above exemplary embodiment encodes the low-priority bit stream signal, and lets the ratio between the frequency domain complex number signals qₚ and qₚ₊₁ of the encoded low-priority bit stream signal to be a positive integer or a negative number.

For example, the above exemplary embodiment let the frequency domain complex number signal qₚ₊₁ of the encoded low-priority bit stream signal ELP1 to be the negative of the frequency domain complex number signal qₚ of the encoded low-priority bit stream signal ELP1, i.e. qₚ₊₁=−qₚ, wherein p is an integer larger than 0, and is an even number or an odd number. Thus the signals Yₚ and Yₚ₊₁ to be de-mapped in the receiver RX1 are expressed as:

Yₚ=HₚQₚ+Iₚ^{(Q)}+Hₚqₚ−C₁H′ₚ₊₁qₚ+ΔIₚ^{(q)}+Zₚ (3)

Yₚ₊₁=Hₚ₊₁Qₚ₊₁+Iₚ₊₁^{(Q)}−Hₚ₊₁qₚ+C₋₁H′ₚqₚ+ΔIₚ₊₁^{(q)}+Zₚ₊₁ (4),

wherein ΔIₚ^{(q)}=Σ_{k=0,k≠p}^{N-1}ΔI_{k,p}qₚ, and ΔIₚ₊₁^{(q)}=Σ_{k=0,k≠p}^{N-1}ΔI_{k,p+1}qₖ is the residual ICI, and k is 0 or a positive even number. From the above equations (3) and (4), by letting the frequency domain complex number signal qₚ₊₁ of the encoded low-priority bit stream signal ELP1 to be the negative of the frequency domain complex number signal qₚ of the encoded low-priority bit stream signal ELP1, i.e. qₚ₊₁=−qₚ, this repetition encoding manner can decrease the BER of the low-priority mapping signal, and guarantee the quality of the transmission signal. Moreover, the ICI is decreased, and the SINRs of the high-priority mapping signal and the low-priority mapping signal are increased.

After the transmitter transmits the mapping signals corresponding to the two neighboring sub-carrier to the receiver RX1, the position of the signal Yₚ to be de-mapped in the receiver RX1 may offset in the constellation map due to the noise and the interference. The de-mapper 120 of receiver RX1 can use the minimum distance criteria to detect the mapping signals Xₚ and Xₚ₊₁ corresponding to the p^{th} and (p+1)^{th} sub-carriers, and that is, to detect the minimum distances between the signal Yₚ to be de-mapped in the constellation map and to mapping signal Xₚ, and between the signal Yₚ₊₁ to be de-mapped in the constellation map and to mapping signal Xₚ₊₁. Therefore, the data of the transmission signal is determined, and the de-mapped signal is generated. The mathematic expression for detecting the minimum distances is expressed as:

$$( {\hat{Q}}_{p} , {\hat{Q}}_{p + 1} , {\hat{q}}_{p} ) = {arg}_{{\tilde{Q}}_{p} , {\tilde{Q}}_{p + 1} , {\tilde{q}}_{p}} min \{ {d}_{p} ( {\tilde{Q}}_{p} , {\tilde{q}}_{p} ) + {d}_{p + 1} ( {\tilde{Q}}_{p + 1} , {\tilde{q}}_{p} ) \} \qquad ( 5 )$$

wherein dₚ(\tilde{Q}ₚ,\tilde{q}ₚ)=|Yₚ−Hₚ\tilde{Q}ₚ−Hₚ\tilde{q}ₚ| is the distance between the signal Yₚ to be de-mapped and the mapping signal Xₚ in the constellation map, and dₚ₊₁(\tilde{Q}ₚ₊₁,\tilde{q}ₚ)=|Yₚ₊₁−Hₚ₊₁\tilde{Q}ₚ₊₁+Hₚ₊₁\tilde{q}ₚ| is the distance between the signal Yₚ₊₁ to be de-mapped and the mapping signal Xₚ₊₁ in the constellation map. \tilde{Q}ₚ and \tilde{Q}ₚ₊₁ are possible ones of the set of the high-priority mapping signal, and \tilde{q}ₚ and \tilde{q}ₚ₊₁ are possible ones of the set of the low-priority mapping signal. Take the exemplary embodiment of FIG. 2 for example, \tilde{Q}ₚ and \tilde{Q}ₚ₊₁ are ones of the set {±3β±3βj, ±β±βj, ±β±3βj, ±3β±βj}, and \tilde{q}ₚ and \tilde{q}ₚ₊₁ are ones of the set {±α±αj}.

Generally speaking, the receiver RX1 first resolves the encoded high-priority bit stream signal EHP1 from the signal S2 to be de-mapped, and determines the encoded high-priority bit stream signal EHP1 transmitted from the transmitter TX1. After obtaining the encoded high-priority bit stream signal EHP1, the receiver RX1 resolves the encoded low-priority bit stream signal ELP1 according to the encoded high-priority bit stream signal EHP1 determined.

For example, assuming the mapping signals Xₚ and Xₚ₊₁ corresponding to the part bits of the encoded high-priority bit stream signal EHP1 are resolved, and the part bits of the encoded high-priority bit stream signal EHP1 high-priority corresponding to the mapping signals Qₚ and Qₚ₊₁ are “1110” and “0100”, the, possible white signal points corresponding mapping signals Xₚ and Xₚ₊₁ are possible ones of A1-A4 and B1-B4, and the frequency domain signal points of the signals Yₚ and Yₚ₊₁ to be de-mapped are Y1 and Y2. When the distances between the signal point Y1 and the white signal points A1-A4 are 2, 3, 4, and 6 unit length, and the distances between the signal point Y2 and the white signal points B1-B4 are 8, 7, 6, and 1 unit length, the signal point B4 is adopted to presents the mapping signal Xₚ₊₁ transmitted from transmitter, and in the similar manner, the signal point A1 is adopted to presents the mapping signal Xₚ transmitted from transmitter. By simultaneously resolving the signals Yₚ and Yₚ₊₁ to be de-mapped, the BER of the low-priority mapping signal is decreased.

It is noted that although the exemplary embodiment determines the data of the transmission signal according to the minimum distance of the mapping signals in the constellation map to which the two neighboring signals to be de-mapped are corresponding, the present invention is not limited thereto. For example, the OFDM demodulator 108 can also determines the data of the transmission signal according to the distances between the signal to be de-mapped corresponding to the single one sub-carrier and the corresponding possible mapping signals, wherein the minimum distance detection theorem is similar to the above exemplary embodiment and not described again.

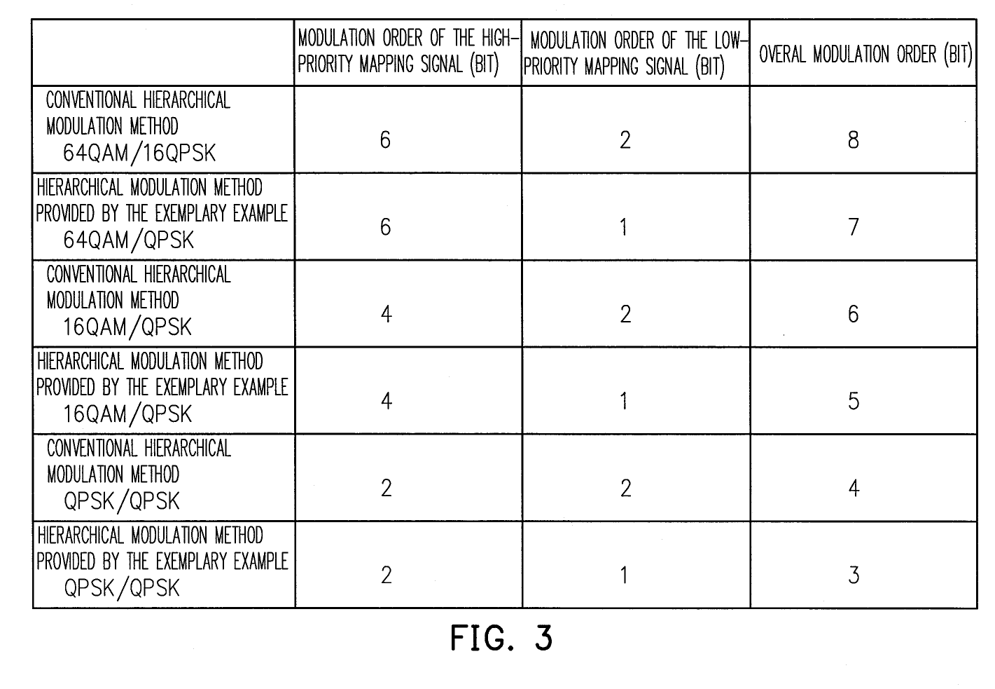

The hierarchical modulation provided by the above exemplary embodiment can maintain the spectrum efficiency of the high-priority mapping signal while the spectrum efficiency of the low-priority mapping signal is decreased half. The modulation order is therefore decreased, and a finer granular resolution is provided. For example, FIG. 3 is a table showing the modulation order of the hierarchical modulation manner according an exemplary embodiment of the present invention. In FIG. 3, the conventional hierarchical modulation manner can transmit a symbol of 8 bits, 6 bits, or 4 bits per unit time. The hierarchical modulation manner uses the repetition encoding manner to encode the signal of the low-priority layer, and therefore the bit transmission rate of the low-priority mapping signal is equivalently is the half of that of the conventional hierarchical modulation manner per unit time. Thus, the bit transmission rate of the conventional hierarchical modulation has more one bit than that of the hierarchical modulation manner according the exemplary embodiment. From FIG. 3, it is obvious that the hierarchical modulation manner according the exemplary embodiment can transmit a symbol of 7 bits, 5 bits, or 3 bits per unit time. A finer granular resolution is provided, and different scheduling processes and radio frequency resource allocations for different transmission systems are therefore provided.

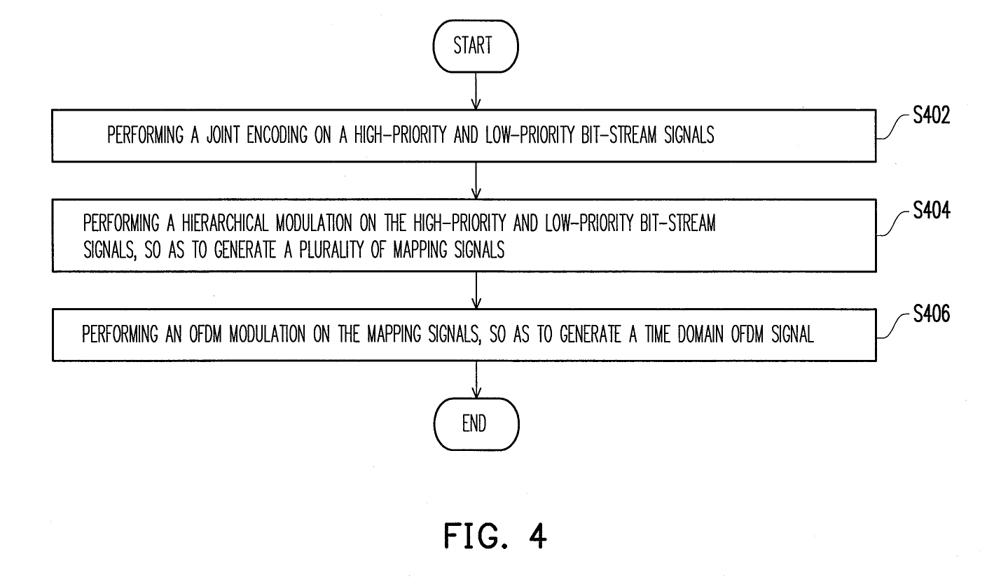

FIG. 4 is a flow chart showing steps of the hierarchical modulation method according to an exemplary embodiment. After concluding the description of the hierarchical modulation method provided by the above exemplary embodiment, the hierarchical modulation method comprises the following steps S402-S406. Referring to FIG. 4, a joint encoder is first used to perform a joint encoding on a first high-priority bit stream signal and a low-priority bit stream signal (step S402). Next, a mapper is used to perform a hierarchical modulation on the encoded high-priority bit stream signal and the encoded low-priority bit stream signal, so as to generate a plurality of mapping signals (step S404). Herein, each mapping signal is the summation of a high-priority mapping signal and a low-priority mapping signal. The high-priority mapping signal is a complex number signal on the frequency domain to which part bits of the encoded high-priority bit stream signal are mapped, the low-priority mapping signal is a complex number signal on the frequency domain to which part bits of the encoded low-priority bit stream signal are mapped. The p^{th} low-priority mapping signal of the low-priority mapping signals is related to (p+1)^{th} low-priority mapping signal of the low-priority mapping signals, and p is an even number or an odd number. Then, an OFDM modulator is used to perform an OFDM modulation on the mapping signals, so as to generate a time domain OFDM signal (step 406).

Accordingly, each mapping signal in the hierarchical modulation transmitter provided by the exemplary embodiment of the present disclosure is the summation of a high-priority mapping signal and a low high-priority mapping signal. In the exemplary embodiment of the present invention, the p^{th} low-priority bit stream signal is appropriately designed for being related to the (p+1)^{th} low-priority bit stream signal, thereby the completeness of the transmitted data is verified, and errors occurred in the transmission period is corrected. Therefore the BER of the communication system is decreased, and ICI is also decreased. Furthermore, a fine granular resolution is also proposed, so as to provide different signal transmission manners, and the flexibility of signal transmission is obtained.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A hierarchical modulation system, comprising:
a transmitter, comprising:
a hierarchical modulator, for receiving a high-priority bit stream signal and a low-priority bit stream signal, and for performing a joint encoding and a hierarchical modulation on the high-priority bit stream signal and a low-priority bit stream signal, so as to generate a plurality of mapping signals, wherein each mapping signal is the summation of a high-priority mapping signal and a low-priority mapping signal, the high-priority mapping signal is a complex number signal on the frequency domain to which part bits of the encoded high-priority bit stream signal are mapped, the low-priority mapping signal is a complex number signal on the frequency domain to which part bits of the encoded low-priority bit stream signal are mapped, wherein the p^{th} low-priority mapping signal of the low-priority mapping signals is related to (p+1)^{th} low-priority mapping signal of the low-priority mapping signals, and p is an even number or an odd number; and
an orthogonal frequency division multiplexing (OFDM) modulator, for receiving the mapping signals, and for performing an OFDM modulation on the mapping signals, so as to generate a time domain OFDM signal; and
a receiver, for receiving the time domain OFDM signal, and for performing an OFDM demodulation, a hierarchical demodulation, and a joint decoding on the time domain OFDM signal, so as to obtain the high-priority bit stream signal and the low-priority bit stream signal.

2. The hierarchical modulation system according to claim 1, wherein the default encoding manner for the low-priority bit stream signal is a repetition encoding.

3. The hierarchical modulation system according to claim 1, wherein the p^{th} low-priority mapping signal is the negative of the (p+1)^{th} low-priority mapping signal.

4. The hierarchical modulation system according to claim 1, wherein the hierarchical demodulator comprises:
a joint encoder, for receiving the high-priority bit stream signal and the low-priority bit stream signal, and for jointly encoding the high-priority bit stream signal and the low-priority bit stream signal; and
a mapper, for receiving the encoded high-priority bit stream signal and the encoded low-priority bit stream signal, and for mapping the high-priority bit stream signal and the low-priority bit stream signal, so as to generate the mapping signals.

5. The hierarchical modulation system according to claim 4, wherein the joint encoder comprises:
a first encoder, for encoding the high-priority bit stream signal; and
a second encoder, for encoding the low-priority bit stream signal according to a default encoding manner and the high-priority bit stream signal.

6. The hierarchical modulation system according to claim 1, the receiver comprises:
an OFDM demodulator, for receiving the time domain OFDM signal, and for performing the OFDM demodulation on the time domain OFDM signal, so as to generate a plurality of signals to be de-mapped; and
a hierarchical demodulator, for receiving the signals to be de-mapped, and for performing the hierarchical demodulation and the joint decoding on the signals to be de-mapped, so as to obtain the high-priority bit stream signal and the low-priority bit stream signal.

7. The hierarchical modulation system according to claim 1, wherein the hierarchical demodulator comprises:
a de-mapper, for receiving the mapping signals, and for de-mapping the signals to be de-mapped, so as to obtain the encoded high-priority bit stream signal and the encoded low-priority bit stream signal; and
a joint decoder, for receiving the encoded high-priority bit stream signal and the encoded low-priority bit stream signal, and for jointly decoding the encoded high-priority bit stream signal and the encoded low-priority bit stream signal, so as to obtain the high-priority bit stream signal and the low-priority bit stream signal.

8. The hierarchical modulation system according to claim 7, the joint decoder comprises:
a first decoder, for receiving the encoded high-priority bit stream signal, and for decoding the encoded high-priority bit stream signal, so as to obtain the high-priority bit stream signal; and
a second decoder, for receiving the encoded low-priority bit stream signal, and for decoding the encoded low-priority bit stream signal according to a default decoding manner and the encoded high-priority bit stream signal, so as to obtain the low-priority bit stream signal.

9. The hierarchical modulation system according to claim 1, wherein a constellation map for the high-priority mapping signal is a 16 quadrature amplitude modulation constellation (16-QAM) map, and a constellation map for the low-priority mapping signal is a quadrature phase-shift keying (QPSK) constellation map.

10. A hierarchical modulation transmitter, comprising:
a hierarchical modulator, for receiving a high-priority bit stream signal and a low-priority bit stream signal, and for performing a joint encoding and a hierarchical modulation on the high-priority bit stream signal and a low-priority bit stream signal, so as to generate a plurality of mapping signals, wherein each mapping signal is the summation of a high-priority mapping signal and a low-priority mapping signal, the high-priority mapping signal is a complex number signal on the frequency domain to which part bits of the encoded high-priority bit stream signal are mapped, the low-priority mapping signal is a complex number signal on the frequency domain to which part bits of the encoded low-priority bit stream signal are mapped, wherein the p^{th} low-priority mapping signal of the low-priority mapping signals is related to (p+1)^{th} low-priority mapping signal of the low-priority mapping signals, and p is an even number or an odd number.

11. The hierarchical modulation transmitter, according to claim 10, further comprising:
an OFDM modulator, for receiving the mapping signals, and for performing an OFDM modulation on the mapping signals, so as to generate a time domain OFDM signal.

12. The hierarchical modulation transmitter, according to claim 10, wherein the default encoding manner for the low-priority bit stream signal is a repetition encoding.

13. The hierarchical modulation transmitter, according to claim 10, wherein the p^{th} low-priority mapping signal is the negative of the (p+1)^{th} low-priority mapping signal.

14. The hierarchical modulation transmitter, according to claim 10, wherein the hierarchical demodulator comprises:
a joint encoder, for receiving the high-priority bit stream signal and the low-priority bit stream signal, and for jointly encoding the high-priority bit stream signal and the low-priority bit stream signal; and
a mapper, for receiving the encoded high-priority bit stream signal and the encoded low-priority bit stream signal, and for mapping the high-priority bit stream signal and the low-priority bit stream signal, so as to generate the mapping signals.

15. The hierarchical modulation transmitter, according to claim 14, wherein the joint encoder comprises:
a first encoder, for encoding the high-priority bit stream signal; and
a second encoder, for encoding the low-priority bit stream signal according to a default encoding manner and the high-priority bit stream signal.

16. The hierarchical modulation transmitter, according to claim 10, wherein a constellation map for the high-priority mapping signal is a 16-QAM map, and a constellation map for the low-priority mapping signal is a QPSK constellation map.

17. The hierarchical modulation transmitter, according to claim 10, the modulation transmitter provides a fine granular resolution for the high-priority bit stream signal and the low-priority bit stream signal.

18. A hierarchical modulation method, comprising:
using a joint encoder to perform a joint encoding on a first high-priority bit stream signal and a low-priority bit stream signal;
using a mapper to perform a hierarchical modulation on the encoded high-priority bit stream signal and the encoded low-priority bit stream signal, so as to generate a plurality of mapping signals, wherein each mapping signal is the summation of a high-priority mapping signal and a low-priority mapping signal, the high-priority mapping signal is a complex number signal on the frequency domain to which part bits of the encoded high-priority bit stream signal are mapped, the low-priority mapping signal is a complex number signal on the frequency domain to which part bits of the encoded low-priority bit stream signal are mapped, wherein the p^{th} low-priority mapping signal of the low-priority mapping signals is related to (p+1)^{th} low-priority mapping signal of the low-priority mapping signals, and p is an even number or an odd number; and
using an OFDM modulator to perform an OFDM modulation on the mapping signals, so as to generate a time domain OFDM signal.

19. The hierarchical modulation method according to claim 18, wherein the default encoding manner for the low-priority bit stream signal is a repetition encoding.

20. The hierarchical modulation method according to claim 18, wherein the p^{th} low-priority mapping signal is the negative of the (p+1) low-priority mapping signal.

21. The hierarchical modulation method according to claim 18, a constellation map for the high-priority mapping signal is a 16-QAM map, and a constellation map for the low-priority mapping signal is a QPSK constellation map.

22. The hierarchical modulation method according to claim 18, wherein the step of generating the time domain OFDM signal comprises:
using the OFDM modulator to perform an inverse fast Fourier transformation on the mapping signals, and then to add a cyclic prefix on the transformed mapping signals, so as to generate the time domain OFDM signal.
